(19) United States
(12) Patent Application Publication
(10) Pub. No.: US 2007/0185995 A1
(43) Pub. Date: Aug. 9, 2007

(54) METHOD AND TELECOMMUNICATIONS EQUIPMENT FOR INTERWORKING INTERNET AND CIRCUIT NETWORKS

(75) Inventors: Steven E. Vanswol, Lombard, IL (US); Trent J. Miller, West Chicago, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/276,017

(22) Filed: Feb. 9, 2006

(51) Int. Cl. G06F 15/173

(52) U.S. Cl. 709/226

(57) ABSTRACT

Methods and telecommunications equipment (102) for routing data are disclosed. The telecommunications equipment includes an interworking telecommunications network element (ITNE) (202) and an Application Controller (AC) (204). The ITNE has multiple connectivity resources. The method includes interworking between a circuit-switched network and a packet-based network through the telecommunications equipment. The method includes detecting a configuration change in the ITNE and advertising a proxy regarding the configuration change for the benefit of the AC. The configuration change is autonomously performed by the ITNE. The proxy is provided by the ITNE. Further, a failover event may be detected by the ITNE, and circuit-switched and packet-based resources of a first board of the ITNE are autonomously transferred to a second board in response to the detection of the failover event.

### FIELD OF THE INVENTION

The present invention relates in general to communication networks, and more specifically, to routing devices in communication networks.

### BACKGROUND OF THE INVENTION

In a communication network, data can be routed through various telecommunications equipment such as soft switches and push-to-talk (PTT) routing equipment. The soft switches and the PTT routing equipment are configured with information pertaining to which network connections or resources are to be utilized to reach other such equipment or network devices.

For example, in an current IP based telecommunications system that includes a Media Gateway (MG) and a Media Gateway Controller (MGC), as they are called in an IDEN® telecommunication system, distributed by Motorola, Inc., of Schaumburg, Ill., the MG can be used to provide connectivity and route data between network devices of an internet protocol (IP) network and a circuit switched network. The configuration of MGs and MGCs is typically performed manually. Each MG is configured with physical connectivity information such as circuit identification and frame relay-channel identification of the connected devices. An MGC uses the physical connectivity configuration information of the MG to manage communication between other network devices. The MGC in a current telecommunications system is therefore aware of which MG resources connect to particular devices or network equipment such as switches or peripherals. The MG can then access the network equipment by using the MG resources designated for the purpose. The MGC maintains a mapping between MG resources and MG-connected devices or networks.

However, the manual configuration of the MG or the MGC may result in at least temporarily incorrect mapping of the connections of devices that are communicated using the networks, or incorrect mapping of network equipment on to the MG. This, in turn, can result in an incorrect allocation of resources by the MGC. As noted above, the soft switch can interwork between two or more different types of networks. For example, a packet-based network can be interworked with a circuit-switched network, to enable devices or network equipment on the two networks to communicate with each other. In an interworking configuration, the soft switch is susceptible to the failure of the MG or MGC. To recover from such failures, the MG or the MGC may be repaired manually. However, manual repair is susceptible to incorrect mapping of the devices or network equipment. In certain circumstances, communication links between the MG and the MGC may fail. This may result in the loss of the data being communicated between the MG and the MGC. Again, this requires manual repair, which is susceptible to incorrect mapping of the devices or network equipment.

### BRIEF DESCRIPTION OF THE DRAWINGS

In the accompanying figures, like reference numerals refer to identical or functionally similar elements throughout the separate views. These, together with the detailed description below, are incorporated in and form part of the specification, and serve to further illustrate the embodiments and explain various principles and advantages, in accordance with the present invention.

FIG. 1 illustrates an example environment, in accordance with some embodiments of the present invention;

FIG. 2 is a block diagram that illustrates an interworking telecommunications network equipment for interworking between a circuit-switched network and a packet-based network, in accordance with some embodiments of the present invention; and

FIG. 3 is a flowchart that illustrates a method for routing data through the telecommunications equipment, in accordance with some embodiments of the present invention;

FIG. 4 is a flowchart that depicts a method for interworking between a circuit-switched network and a packet-based network, in accordance with some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements, to help in improving an understanding of embodiments of the present invention.

### DETAILED DESCRIPTION OF THE DRAWINGS

Before describing in detail the particular method and system for routing data in accordance with the present invention, it should be observed that the present invention resides primarily in combinations of method steps and system components related to routing of data through telecommunications equipment. Accordingly, the system components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

In this document, relational terms such as first and second, and the like may be used solely to distinguish one entity or action from another entity or action without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

The present invention describes a method for routing data through a telecommunications equipment. The telecommunications equipment includes one or more interworking telecommunications network elements (ITNE) and an Application Controller (AC), which are names used herein to describe equipment that may be used in any telecommunications system. One example of such a telecommunication system is an IDEN system, which includes interworking telecommunications network elements (ITNEs) known as Media Gateways and application controllers (ACs) known as Media Gateway Controllers. The method includes detecting a configuration change in the ITNE, and providing the Application Controller (AC) with information pertaining to the configuration change. The configuration change is detected by the ITNE. The method also includes updating the routing information on the AC, based on the information relating to the configuration change; and sending the routing information, based on the information about the configuration change to the ITNE for routing the data.

The present invention further describes telecommunications equipment for routing data. The telecommunications equipment includes one or more interworking telecommunications network elements (ITNE) and an Application Controller (AC). Each ITNE includes a plurality of connectivity resources. The ITNE is capable of making a configuration change to its resources and provides information to the AC regarding the configuration change. The AC is communicably coupled to the ITNE, which may be through a network. The AC is capable of updating routing information in the AC based on information regarding the configuration change, and sending the routing information to the ITNE for routing the data.

Moreover, the present invention describes a method for interworking between a circuit-switched network and a packet-based network through telecommunications equipment. The telecommunications equipment includes an interworking telecommunications network elements (ITNE) and an Application Controller (AC). The ITNE includes at least a first board and a second board. The first and second boards include one or more circuit-switched resources and one or more packet-based resources.

The method includes the ITNE autonomously defining a new channel in the circuit switched network and using it to establish a communication path, identifiable by a proxy, between a circuit device and one or more IP devices or circuit devices, or both, and advertising the proxy. The method also includes detecting a failover event in the ITNE involving a communication path previously established within the ITNE, and autonomously transferring, by the ITNE, one or more circuit-switched resources in parallel with one or more packet-based resources that are within the communication path, from the first board to the second board in response to the detection of the failover event. The terminology “switching the resources”, or similar wording, may be used herein to mean that the communication function which a first set of resources (which may be a combination of software and physical hardware that performs a function of routing communication information signals) provides is transferred to a second set of physical resources, without affecting proxy information that is used by network elements outside the ITNE to route communications using the communications path. In accordance with some of the embodiments, the ITNE is able to transfer resources that are used for such a communication path between a circuit switched network and an IP network, essentially simultaneously; that is, without the communication path being dropped. Some data information being conveyed over the communication path may end up being retransmitted, but the path is maintained, using the same proxy. Thus, the ITNE does not need to advertise the failover event to the elements using the communication path.

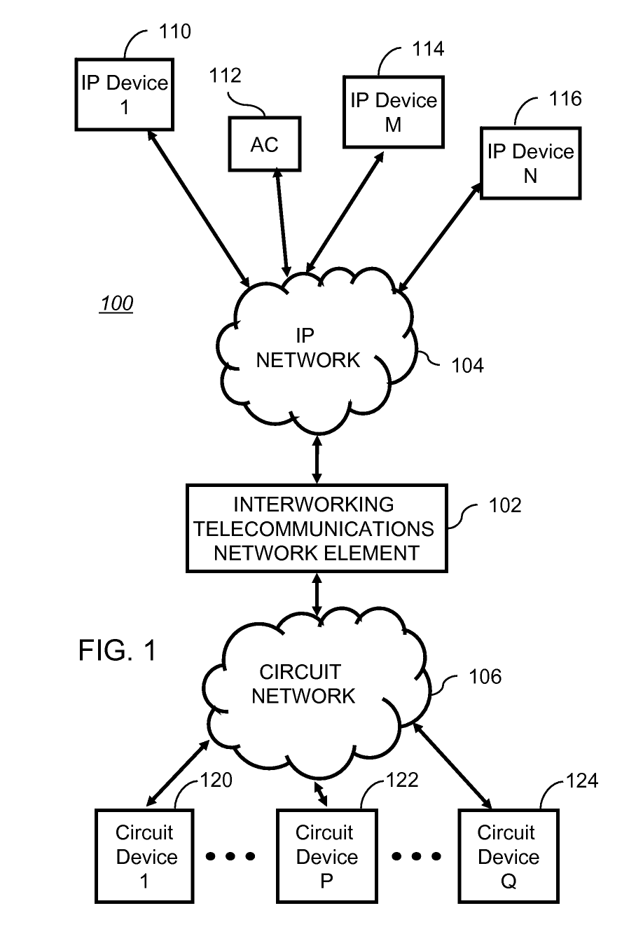

FIG. 1 illustrates an example communication networking environment 100, in accordance with some embodiments of the present invention. In the environment, an interworking telecommunications network element (ITNE) 102 connects in a first network 104 and a in a second network 106 to establish communication between at least one element of the first network 104 and at least one element of the second network 106. Examples of the first network 104 and the second network 106 include, but are not limited to Internet Protocol (IP)-based networks, Time Division Multiplexing (TDM) based networks, Public Switched Telephone Networks (PSTN), Wide Area Networks (WAN), Wireless Local Area Networks (WLAN), and other communication networks. Examples of the ITNE 102 include, but are not limited to a soft switch, IMS application server and a push-to-talk (PTT) server. It will be apparent to a person of ordinary skill in the art that the ITNE 102 can act as an interface between several networks. The number of networks the ITNE can support depends on the configuration of the ITNE 102. In accordance with embodiments of the present invention, the ITNE 102 can act as an interworking element between an internet protocol (IP) network and a circuit switched network. In one example, the network 104 may be an IP network that provides communications between N IP network devices that include devices 110, 112, 114, 116, while network 106 may be a circuit switched network that provides communication between Q circuit switched network devices that include elements 120, 122, 124. Of course, the number of network devices, N and Q, may be varying. Also, some of the network elements may be of the type that provide communication paths within the respective networks, and some may be elements that provide some control functions. The application control (AC) element 112 of IP network 104 in this example is an application controller, which in an IDEN® system is called a media gateway controller, and provides some control functions. In an example of the operation of the embodiments of the present invention, an IP device, such as IP device M 114 may indicate to AC 112 a request to communicate with circuit device P 122. The AC 112 may then command the ITNE 102 to establish a communication path for this purpose, which it does, and informs the AC 112 of the proxy for the communication path. The proxy includes information that identifies the path to the participants (which include IP device M 114, AC 112, ITNE 102, and Circuit Device 122) so that messages may be routed using the proxy information and the resources of the networks (physical resources as well as radio frequency related resources) managed.

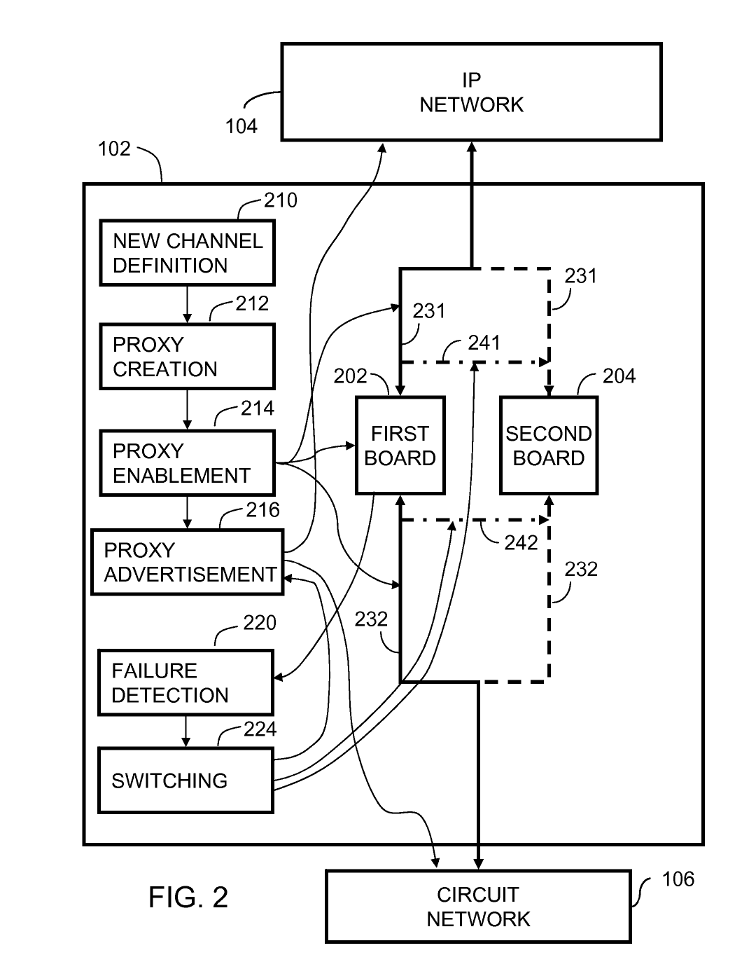

FIG. 2 illustrates a block diagram of the ITNE 102, in accordance with some embodiments of the present invention. In this case, the first network 104 is a packet-based network, for example, an Internet Protocol (IP) based network and the second network 106 is a circuit-switched network, for example, a Time Division Multiplexed (TDM) network. For the purpose of interworking, the ITNE 102 includes a first board 202 and a second board 204.

The first board 202 includes circuit-switched resources and packet-based resources for interworking between the circuit-switched network 106 and the packet-based network 104. The second board 204 is a spare board that is reserved for future use, for example, upon a failure of the first board 202.

The ITNE 102 further comprises many functions, just some of which are: a new channel definition function 210, a proxy creation function 212, a proxy enablement function 214, a proxy advertisement function 216, a failure detection function 220, and a switching function 222. These functions may be implemented entirely in software, partially in software and partially in hardware, or entirely in hardware. Software in this context means programming instructions executable or executed on a processor, while hardware means what is called a state machine; that is a set of logic that may be, but is not necessarily, clock driven, but does not have an associated set of programming instructions, and may be implemented in many cases by custom or application specific integrated circuits. When implemented in any of these fashions, the implementation is a means for performing the function. The hardware may include devices that may not be classified as logic, such as switches, line drivers, power or voltage level converters, etc.

The means for new channel definition 210 has an output that conveys the new channel definition to the means for proxy creation 212, which in turn has an output for conveying the new proxy definition to the means for proxy enablement 214. The means for proxy enablement 214 can establish a communication path 231, 232 from the IP network through the first board 202 to the circuit network 106 that is uni-directional or bi-directional, and has an output that conveys information about the established path to the means for proxy advertisement 216, which can advertise a proxy on either or both the IP network 104 and the circuit network 106.

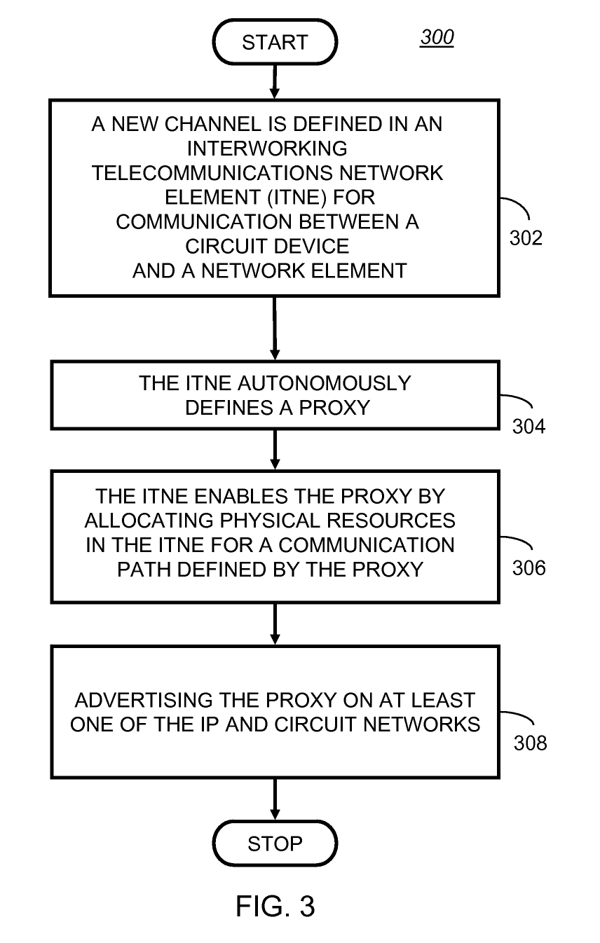

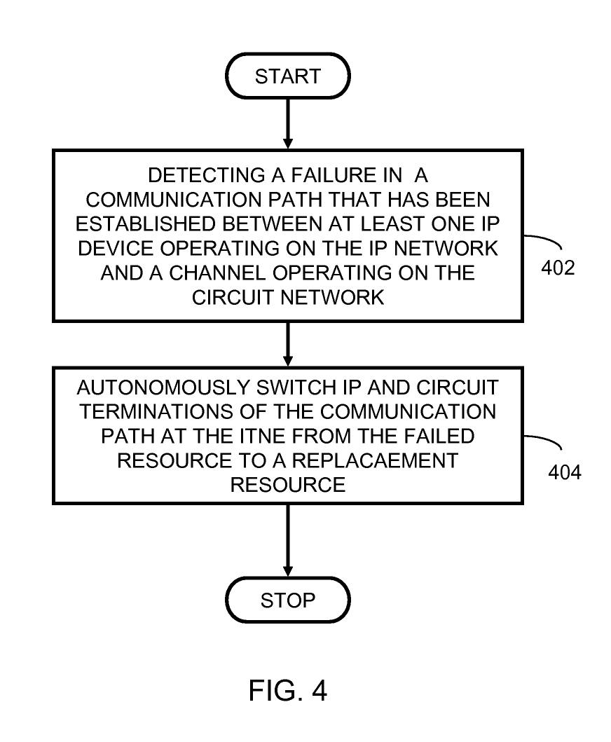

The means for failure is coupled to the connectivity resources such as the first and second boards 202, 204, and can detect any one or more of a set of failures that would reduce or stop the throughput of a communication path, such as the one from IP device M 114 and circuit device P 122. When such a failure is detected, the existence of the failure is communicated to the means for switching 224, which can control switches 241, 242 to change the connections of the communication path 231, 232 to the second board, as illustrated by the dotted lines in FIG. 2. The means for failure detection 224 in some embodiments is coupled to the means for proxy advertisement 216. as indicated in FIG. 2, to initiate a proxy advertisement. Although not shown in FIG. 2, the means for switching 224 may be coupled to other functions in the ITNE 102, including one or more of the functions 210, 212, 214 to determine information or control aspects of the ITNE 102 in response to a failure. These functions are further described below with reference to FIGS. 3 and 4, in which the operation of a function described with reference to FIG. 2 may be further described with reference to corresponding steps.

Referring to FIG. 3, a flowchart depicts some steps of a method for interworking between the circuit-switched network 106 and the packet-based network 106 through the ITNE 106, in accordance with some embodiments of the present invention. At step 302, the ITNE 102 defines a new channel in the circuit switched network 106 comprising one or more DS0 circuits. The new channel is for use by at least one circuit device in the circuit switched network 106 to communicate with at least one other network device, which may be an device operating in the IP network 104 or circuit switched network 106, or more than one device in one or both types of networks. The ITNE 102 may define the new channel in response to, for example, a request from the AC 112 over the IP network to establish a new communication path.

The ITNE 102 then may autonomously create a proxy at step 304 by binding IP transport information with information that identifies the new channel. The proxy may be of a conventional type. The proxy is then autonomously enabled by the ITNE 102 by allocating physical resources of the ITNE 102 that establish a communication path at step 306 that is defined by the binding. The communication path may be unidirectional or bidirectional. The resources are physical resources that may include software instructions, and may be substantially of a conventional design. At step 308, the proxy is autonomously advertised on at least one of the networks involved in the communication path. Typically, the proxy would be advertised on the IP network to the AC 112 so that the AC 112 can manage the resources (physical and radio frequency related) of the IP network. Advertising the proxy includes advertising IP transport information including such information as a proxy IP address and port for one device on the IP network and at least one logical device identity that represents a device on the circuit network that can be communicated with by using the IP transport information. The IP transport information may include either an IP V6 packet with a layer 4 transport number or an IP V4 packet with a layer 4 transport number. This IP transport information could be used to service any transport protocol, such as User Datagram Protocol, Transmission Control Protocol, or Stream Control Transmission Protocol. The steps might be performed in an order other than that stated, although of course the proxy is advertised after it is defined. For example, the proxy could conceivably be advertised shortly before the communication path is completed.

Provisions may be included after the proxy is advertised to assure that the proxy gets delivered to the AC 112, in order to allow the AC 112 to maintain good control of the IP network. These provisions could involve acknowledgement messages from the AC 112 or periodic advertisement of the new proxy.

This new method uniquely provides more efficient operation of the interworking aspects of the IP and circuit switched networks by having the network element that implements the communication path determine the resources to use and define and advertise the proxy.

Referring to FIG. 4, a flowchart depicting some steps of a method for interworking between the circuit-switched network 106 and the packet-based network 104 through the ITNE 102 is shown, in accordance with some embodiments of the present invention. During the interworking process, many communication paths may be established. One communication path that has been established between at least one IP device operating on the IP network and a channel operating on the circuit network is identified by a first proxy. The first proxy is a binding of IP transport information with the channel of the circuit network. The channel operating on the circuit network comprises one or more DS0 circuits that are used to establish communication with one or more circuit devices. The IP transport information typically comprises either an IP V6 packet with a layer 4 transport number or an IP V4 packet with a layer 4 transport number. This communication path could be used to service any transport protocol such as User Datagram Protocol, Transmission Control Protocol, and Stream Control Transmission Protocol. The communication path has been established using physical resources of a first board 202 in the ITNE 102. The communication path may be unidirectional or bidirectional. The physical resources of the first board 202 may then fail (i.e., the first board may fail). The failure of the first board 202 is detected or anticipated by the ITNE 202, which action will be hereafter, for simplicity, be described as a physical failure being detected by the ITNE 102. The detection of the failure by the ITNE 102 may be referred to as a failover event. In other words, when it stated that the ITNE 102 detects a failure, what is meant is that the ITNE 102 detects the requirement for transferring the resources of the first board 202 before, during, or just after the failure of the first board 202. At step 402, the failure is detected in the communication path identified by the first proxy. Upon the detection of the failure, the ITNE 102 autonomously switches, at step 404, the IP and circuit terminations of the communication path at the ITNE from the failed physical resource (the first board 202) to a replacement physical resource (the second board 204) within the ITNE 102. It may be in some embodiments that the failed physical resources are on different “boards”, depending on the maintenance architecture of the ITNE 102 (for example, the different resources may be in different plug in modules that are not termed “boards”. The transfer ensures that the AC 112 is insulated from and not substantially affected due to the failure of the ITNE 102. In other words, the ITNE 102 autonomously transfers the resources. In some embodiments of the present invention, the external network characteristics of the ITNE 102, such as its circuit identification or IP network address and port numbers remain unchanged in the event of the failure of these communication path resources. The AC 112 continues to access the resources through the MG 102 in the same manner as before the detection of the failover event. Internally, the ITNE 102 transfers the resources to the second board 204 by assigning the second board 204, for example, the IP network address, the port number, and circuit identification corresponding to the first board 202, and the communication path continues to be identified by the first proxy. The transfer is effected sufficiently quickly that the devices using the communication path maintain communication using the first proxy after the failure. In some embodiments, the first proxy is re-advertised after the resources are switched, along with an indication of loss of resources, so that the AC 112 may manage the network resources (physical as well as radio frequency related) effectively. In some embodiments, the first proxy is not advertised after the switchover. In some embodiments, a second proxy is assigned for the communication path, wherein the second proxy includes different IP transport information than the first proxy. In these embodiments, the second proxy is advertised on the IP network

The switching of resources is performed by utilizing, for example, an Open Shortest Path First (OSPF) protocol. In one such case, when the first board 202 serves only Ethernet traffic fails, the resources are transferred by using the OSPF protocol. This maintains the connectivity of the AC 112 with the resources.

Since the circuit-switched resources and the packet-based resources are transferred together or in parallel, the AC 204 can remain synchronized with the resources without any interruptions. Further, the routing information is synchronized between the ITNE 102 and the AC 204. Synchronization is performed in a manner that is similar to that described earlier, for embodiments pertaining to the routing of data. In some embodiments of the present invention, the ITNE 102 provides the AC 112 with the routing information in the form of a proxy. This process is repeated until the ITNE 102 receives an acknowledgement from the AC 112. In another embodiment of the present invention, the ITNE 102 provides the AC 112 with the routing information when the AC 112 makes a request to the MG 102 for the routing information.

Embodiments of the present invention enable the telecommunications equipment to route data effectively. The ITNE 102 may advertise the mapping of its resources to a network device and to the AC 112. The AC 112 therefore has information available that enables it to route the data to a destination. Further, while interworking two or more different networks, the AC 112 is insulated from the failures of the ITNE 102 or elements of the ITNE 102.

It will be appreciated the components described herein may be comprised of one or more conventional processors and unique stored program instructions that control the one or more processors to implement, in conjunction with certain non-processor circuits, some, most, or all of the functions of the components described herein. The non-processor circuits may include, but are not limited to, a receiver, a transmitter, signal drivers, clock circuits, power source circuits, and user input devices. As such, these functions may be interpreted as steps of a method to perform interworking in a communication network. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and components for these functions have been described herein.

It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. An interworking telecommunications network element (ITNE) for interworking internet (IP) and circuit networks, comprising:
means for defining a new channel comprising one or more DS0 circuits, wherein the new channel is for use by at least one circuit device to communicate with at least one network device within one or both of the IP and circuit networks;
means for autonomously creating a proxy by binding IP transport information with the new channel;
means for enabling the proxy by allocating physical resources in the interworking telecommunications network element that establish a communication path defined by the binding; and
means for advertising the proxy on at least one of the IP and circuit networks.

2. The ITNE according to claim 1, wherein the proxy includes IP transport information and at least one logical device identity that represents a device on the circuit network that can be communicated with by using the IP transport information.

3. The ITNE according to claim 2, wherein the IP transport information comprises one of an IP V6 packet with a layer 4 transport number and an IP V4 packet with a layer 4 transport number.

4. The ITNE according to claim 1, wherein the communication path is one of unidirectional and bidirectional.

5. The ITNE according to claim 1, wherein the ITNE provides proxy information in response to a request made on the IP network.

6. An interworking telecommunications network element (ITNE) for interworking (ITNE) an internet (IP) network and circuit networks, comprising:
means for detecting a failure in a communication path that has been established between at least one IP device operating on the IP network and a channel operating on the circuit network, wherein the communication path is identified by a first proxy, and wherein the failure is attributed to a failed physical resource in the ITNE; and
means for autonomously switching IP and circuit terminations of the communication path at the ITNE from the failed physical resource to a replacement physical resource within the ITNE.

7. The ITNE according to claim 6, wherein the communication path is one of a uni-directional and a bi-directional communication path.

8. The ITNE according to claim 6, wherein the first proxy is a binding of IP transport information with the channel of the circuit network.

9. The ITNE according to claim 8, wherein the channel operating on the circuit network comprises one or more DS0 circuits that are used to establish communication with one or more circuit devices.

10. The ITNE according to claim 8, wherein the IP transport information comprises one of an IP V6 packet with a layer 4 transport number and an IP V4 packet with a layer 4 transport number.

11. The ITNE according to claim 6, wherein the communication path continues to be identified by the first proxy.

12. The ITNE according to claim 11, wherein the means for switching operate sufficiently quickly that the at least one IP device and the circuit device maintain communication using the first proxy after the failure.

13. The ITNE according to claim 11, wherein the means for switching advertise the first proxy on the IP network in response to the autonomous switching of the IP and circuit terminations.

14. The ITNE according to claim 6, wherein the ITNE advertises no proxy on the IP network in response to the autonomous switching of the IP and circuit terminations.

15. The ITNE according to claim 6, wherein in response to the autonomous switching of the IP and circuit terminations, the means for switching assigned a second proxy for the communication path, and wherein the second proxy includes different IP transport information than the first proxy, and wherein the means for switching advertise the second proxy on the IP network.
